(19) United States
(12) Patent Application Publication
(10) Pub. No.: US 2010/0007603 A1
(43) Pub. Date: Jan. 14, 2010

(54) METHOD AND APPARATUS FOR CONTROLLING DISPLAY ORIENTATION

(75) Inventor: Kevin Scott Kirkup, Raleigh, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB

(21) Appl. No.: 12/172,785

(22) Filed: Jul. 14, 2008

(51) Int. Cl. G06F 3/033

(52) U.S. Cl. 345/158

(57) ABSTRACT

An approach provides controlling of display orientation in a mobile device. Motion of a mobile device having a plurality of displays is detected, wherein each of the displays is configured to present an image. Orientation of one or more of the images is changed on the displays in response to the detected motion.

### BACKGROUND INFORMATION

Applications for mobile devices continue to provide greater functionality. In addition to conventional voice capabilities, these devices permit users to connect to a variety of information and media sources such as the Internet as well as watching movies, reading and writing text messages and emails, or making phone calls, at times concurrently. Unfortunately, as the richness and complexity of these applications increase, the complexity of the user interface increases commensurately. For example, mobile devices have been developed in a variety of configurations, with various display options. It has become an increasingly greater challenge for the user to manage and control the use of these displays, particularly when the mobile devices support numerous applications that need to be optimized for the particular display configurations. Compounding this problem is the fact that users can position the displays in a host of orientations. Thus, one display or screen configuration may be optimal in one orientation, but not in another. Traditionally, the orientation of the device has not been fully integrated with the users' display preferences.

Therefore, there is a need for a display management approach that accounts for the orientation of the mobile device and/or the applications.

### SOME EXEMPLARY EMBODIMENTS

According to one exemplary embodiment, a method comprises detecting motion of a mobile device having a plurality of displays, wherein each of the displays is configured to present an image. The method also comprises changing orientation of one or more of the images on the displays in response to the detected motion.

According to another exemplary embodiment, an apparatus comprises a detector configured to detect motion of a mobile device having a plurality of displays, wherein each of the displays is configured to present an image. The apparatus also comprises a control module configured to change orientation of one or more of the images on the displays in response to the detected motion.

According to yet another exemplary embodiment, a mobile device comprises a plurality of displays, wherein each of the displays is configured to present an image. The device further comprises a processor configured to detect motion of the mobile device, and to change orientation of one or more of the images on the displays in response to the detected motion.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of system capable of managing multiple displays of a mobile device, according to an exemplary embodiment;

FIG. 2 is a flowchart of process for updating image orientation, according to an exemplary embodiment;

FIGS. 3A-3C are diagrams of a mobile device having multiple displays that can be controlled based on movement, according to various exemplary embodiments;

FIG. 4 is a diagram of a mobile device having a single display providing multiple screens, according to various exemplary embodiments;

FIG. 5 is a flowchart of a process for modifying screen configurations based on a detected event, according to an exemplary embodiment;

FIGS. 6A and 6B are diagrams of screen orientations dependant on device rotation, according to various exemplary embodiments;

FIG. 7 is a flowchart of process for allowing a user to input display configuration parameters, according to an exemplary embodiment;

FIG. 8 is a flowchart of a process for a user to set display configurations for various events, according to an exemplary embodiment; and

FIG. 9 is a diagram of exemplary components of the mobile device of FIG. 1, according to an exemplary embodiment.

### DESCRIPTION OF THE PREFERRED EMBODIMENT

A preferred apparatus, method, and software for controlling display orientation based on device orientation are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a mobile device operating in a cellular network, it is contemplated that various exemplary embodiments are applicable to other devices and networking technologies.

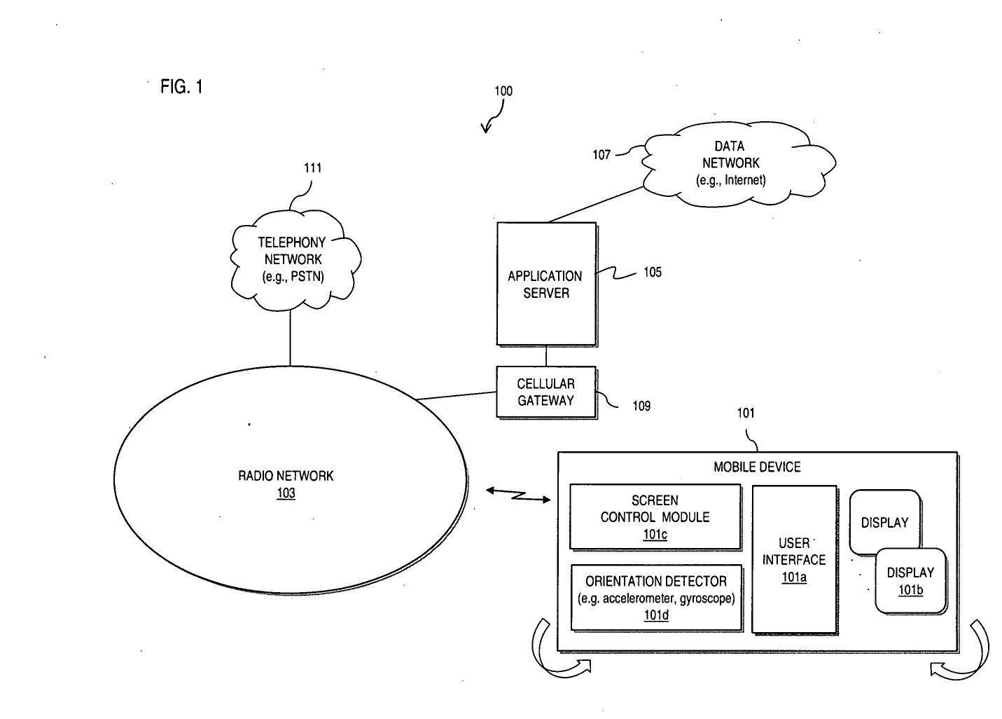

FIG. 1 is a diagram of system capable of managing multiple displays of a mobile device, according to an exemplary embodiment. For the purposes of illustration, a mechanism for updating displays based on movement is described with respect to a communication system 100 that includes a mobile device 101 operating in a radio network 103, such as a cellular network. Thus, the mobile device 101 can include telephony capabilities for conducting voice communications. It is contemplated that the mobile device 101 can be any type of electronic device, such as a cell phone, laptop, personal digital assistant (PDA), web appliance, etc. By way of example, the network 103 may employ various technologies including, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Components of the mobile device 101 can include a user interface 101a and one or more display units 101b. These display units 101b may be physically separate displays or virtually defined screens within one or more physical displays. In addition, the mobile device 101 includes a screen control module 101c for managing and controlling the displays 101b. The mobile device 101 also utilizes an orientation detector 101d that operates in conjunction with the control module 101c to update (or change) the images on the displays 101b. Specifically, the mobile device 101 utilizes the orientation detector 101d to detect a certain level and/or type of motion (e.g., rotation) to trigger update of display orientation for the screen control module 101c. For example, the orientation detector 101d can include an accelerometer, a gyroscope, a magnetometer, or any type of Micro Electro-Mechanical Systems (MEMS).

Screen control module 101c can manage and control the device display(s) 101b according to, in certain embodiments, a manufacturer's predefined configuration or user defined configuration. In other words, the user may specify, as user preferences, the manner in which the displays 101b are controlled, and the parameters associated with the triggering mechanisms for updating the displays based on device movement (e.g., rotational force and/or position). Such user preferences may also correlate the display (or screen) configurations with applications (e.g., browser, media player, etc.) and/or events—e.g., call, email or text message. Other events can include user defined events, software events, or keypress events.

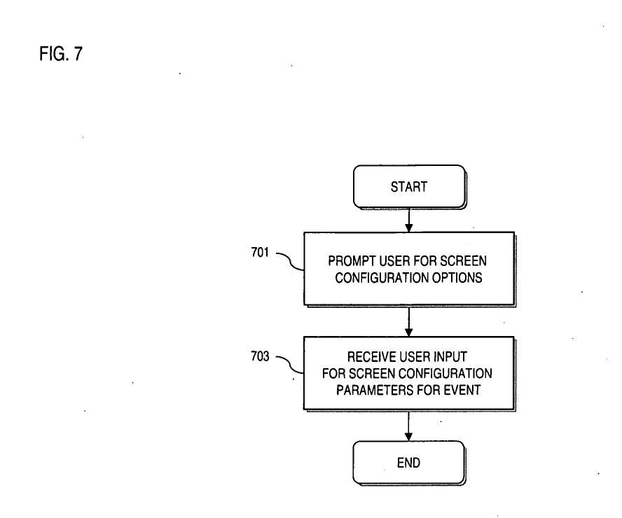

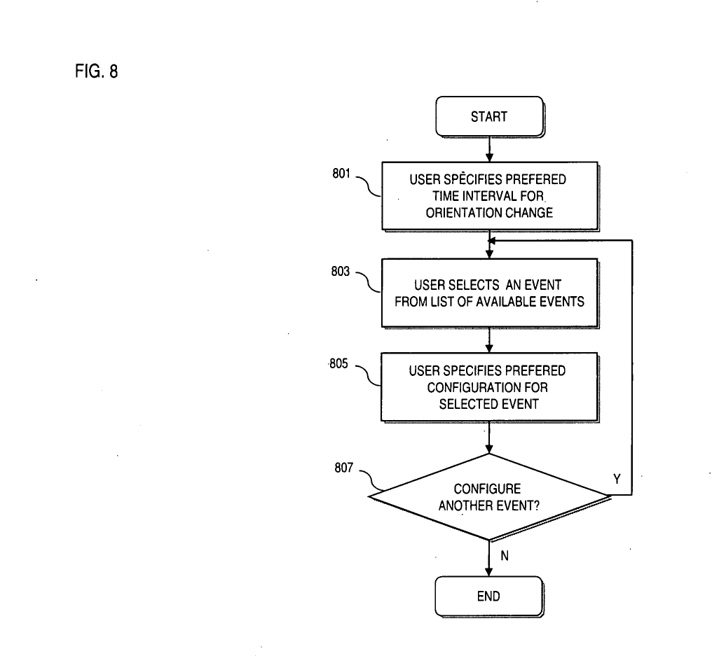

Furthermore, users can specify how they want the display(s) rearranged when a triggering event such as an incoming or outgoing call, email or text message is underway. This process of specifying user preferences for display configurations is more fully described later with respect to FIGS. 7 and 8.

As seen in FIG. 1, an application server 105 can interact with the mobile device 101 to supply information by interfacing with a data network 107. The data communicated via data network 107 can be downloaded by the mobile device 101 via application server 105 and a cellular gateway 109. The data network 107 may be any local area network (LAN), metropolitan area network (MAN), wide area network (WAN), the Internet, or any other suitable packet-switched network, such as a commercially owned, proprietary packet-switched network, e.g., a proprietary cable or fiber-optic network.

The radio network 103 has connectivity to a telephony network 111, such as a Public Switched Telephone Network (PSTN), to allow the mobile device 101 to establish voice communications with terminals served by the telephony network 111.

The operation of the mobile 101 for controlling the displays 101b (or screens) based on device motion is explained below.

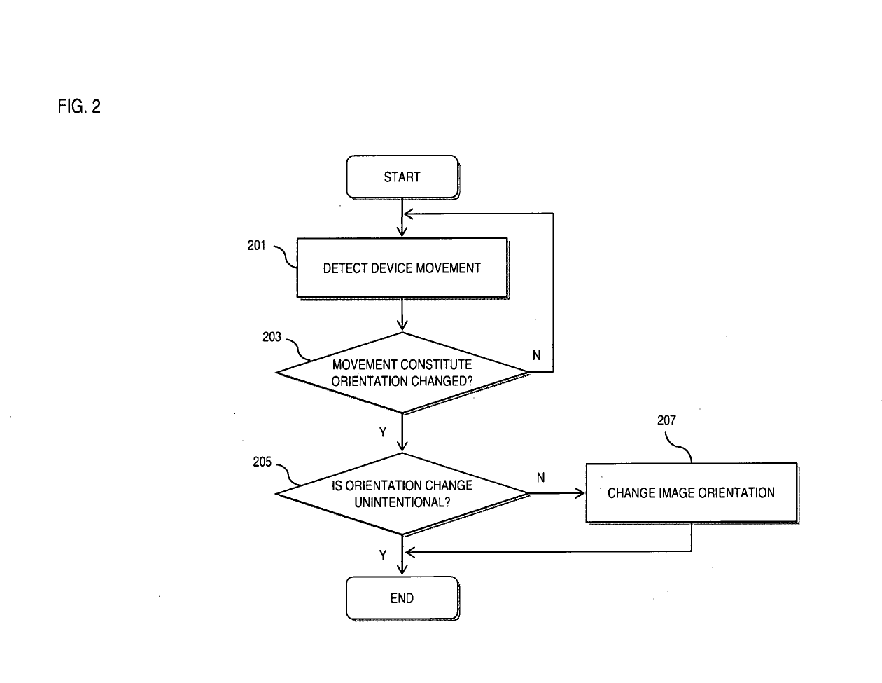

FIG. 2 is a flowchart of process for updating image orientation, according to an exemplary embodiment. In step 201, movement of device 101 is detected by orientation detector 101d. One example of device movement is rotational in nature. In one embodiment, the screen control module 101c controls the screens of displays 101b in a way that when the device 101 is rotated, these screens are adjusted to maintain the same viewing orientation for the user. Otherwise, the user would be required to tilt his/her head to view the screen. For instance, if the user rotates the device 101 by 90° in a clockwise direction, then the screen control module 101c may rotate the screen (or image) on the display appropriately—i.e., by 90° in a clockwise direction.

It is noted that it would be undesirable to update the displays 101b when the movement is unintentional. Therefore, in step 203, the screen control module 101c determines whether the amount of device movement constitutes an orientation change as opposed to unintentional movement. This determination may be based on movement and/or time. For example, if the device 101 is only tilted to one side with a small angle or if it is rotated for a small fraction of time and then rotated back into its initial orientation, the motion might be considered as an accidental movement, and thus, can be ignored. Otherwise, updating of the displays 101b may unnecessarily consume power and other resources of the device 101; moreover, the rapid image transitions may be distracting to the user.

Accordingly, the process, as in step 205 determines whether the orientation change is unintentional (or temporary). This can be based on a duration threshold, whereby if the threshold is exceeded (or otherwise satisfied), the movement is deemed to be intentional (and not temporary). This time threshold can be predefined by the manufacturer or specified by the user.

If orientation change is not temporary, the image (or screen) orientation is changed, per step 207, by screen control module 101c such that the user can maintain the same viewing perspective.

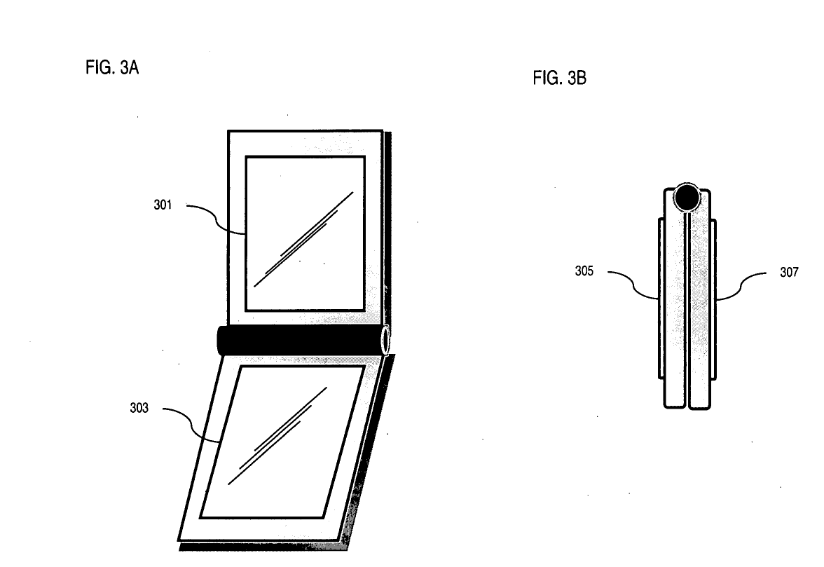

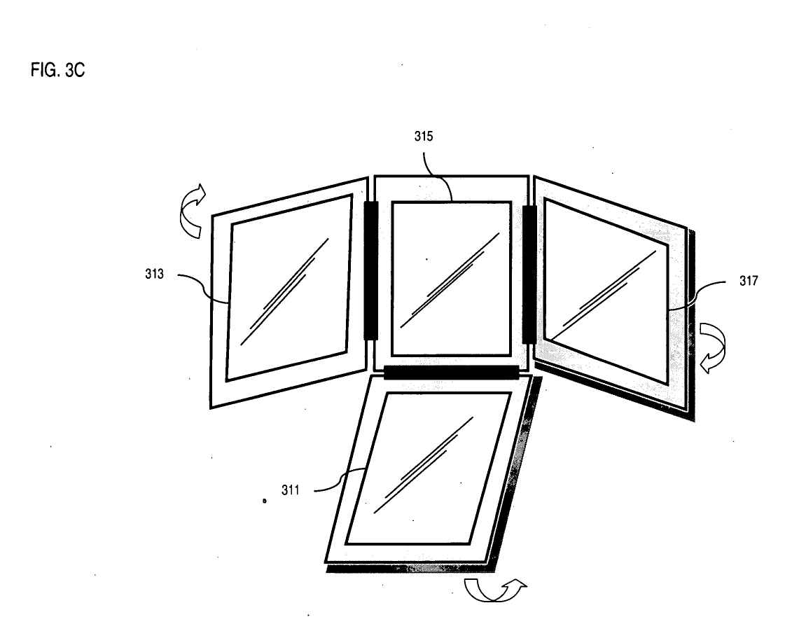

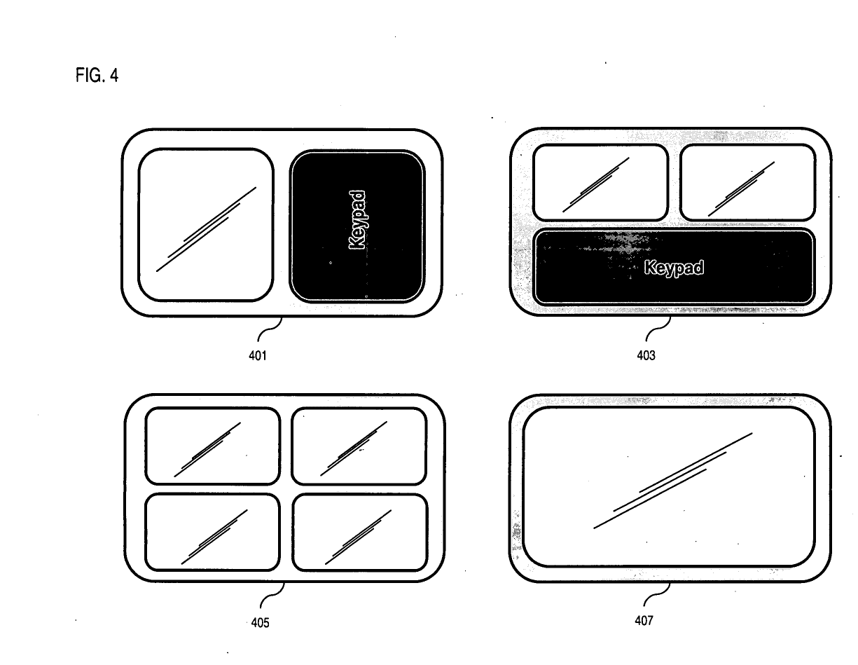

The device 101 can be arranged in various configurations for its displays 101b, as shown in FIGS. 3A-3C and 4. It is contemplated that different types of displays 101b (e.g., touch screen, non-touch screen, etc.) can be implemented on a single device, depending on such factors as functionality and cost.

FIGS. 3A-3C are diagrams of a mobile device having multiple displays that can be controlled based on movement, according to various exemplary embodiments. Shown in FIGS. 3A and 3B are different views of a clamshell design of the mobile device 101. Specifically, the FIG. 3A shows the mobile device 101 in an open position, wherein two displays 301, 303 are included. The display 303 can serve as a “soft keypad”; and thus, the display 303 is a touch screen display. Depending on the application, the keypad may be replaced by other images or controls. For instance, if the user launches a video application and rotates the device 101 as to position the displays 301, 303 in a landscape format, both displays can present the video content.

FIG. 3B illustrates the mobile device 101 in a closed position. In this example, additional displays 305, 307 can be installed on the outside of the device 101.

As earlier mentioned, the mobile device 101 can utilize different types of displays. This clamshell device can employ inner displays 301, 303 as touch screens wherein one of the displays 301, 303 could be assigned as a keypad when needed, while the outer displays 305, 307 could be used only for image presentation and not as touch screens.

In an exemplary embodiment, the user could watch a movie on the outside displays 305, 307 while sending or receiving calls, emails and text messages on the inside displays 301, 303 by rotating the device 101 clockwise or counterclockwise by 90°. It is contemplated that the displays 301-307 can rotate the images in smaller, configurable increments (e.g., 5°, 10°, 45°, etc.).

As seen in FIG. 3C, the mobile device 101 can comprise foldable displays 311, 313, 315, and 317. These displays 311, 313, 315, and 317 can be arranged in a clamshell-like structure whenever the device 101 is not in use. As indicated by the arrows, the multiple thin displays 311, 313, 315, and 317 can be folded, whereby the panel housing display 313 folds behind the panel of display 315. The panel housing display 317 can be positioned in front of display 315. Lastly, the panel with display 311 can collapse behind the folded panels (corresponding to displays 313-317). It is noted that the hinges are of varying sizes to accommodate the closed clamshell position.

In an exemplary embodiment, the lower display 311 can be used as a keypad while the top displays 313-317 can be used for other controls, images, or video content.

In addition to providing independent controls of the displays 301-317, the screen control module 101c can manipulate screens presented within a single physical display.

FIG. 4 shows diagrams of a mobile device having a single display providing multiple screens, according to various exemplary embodiments. Display configurations 401-407 are exemplary layout of screens, which can be arranged based on the applications (e.g., email, text messaging, voice call, etc.) and user preferences. These configurations 401-407 utilize one physical display that presents one or more virtual displays (i.e., screens or picture). Configuration 401 provides a touch screen display in which a soft keypad is provided on the right, and a screen for other controls and information on the left. Alternatively, configuration 403 utilizes three screens: the bottom screen providing a keypad, and the top two are screens (wherein independent applications can be executed). Configuration 405 splits the display into four separate screens, while configuration 407 involves a single screen. In any of the above display configurations 401-407, one or more of the screens can be set to change orientation if rotated by the user. Also, it is contemplated that movement (e.g., rotation) of the device 101 can alter one configuration to another, in addition to orientation adjustments of the screens. In one embodiment, the screen control module 101c permits independent manipulation of the screens.

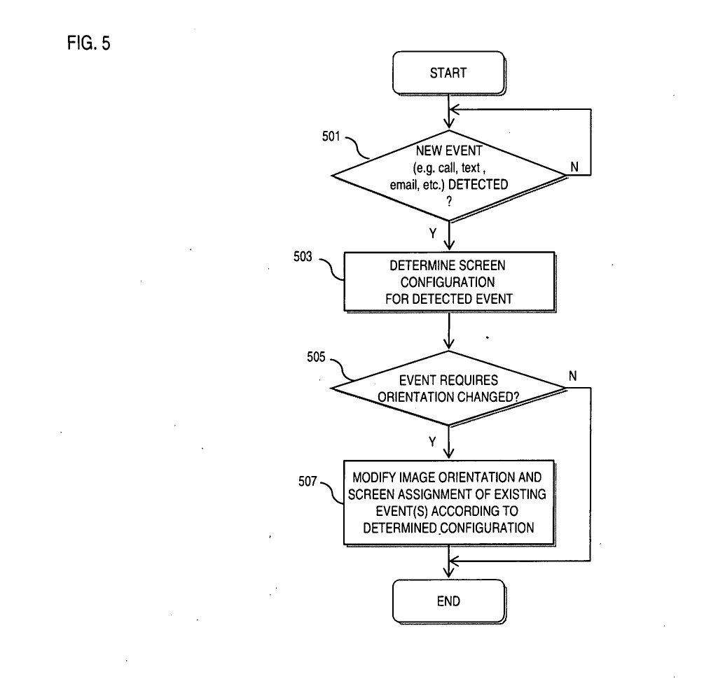

FIG. 5 is a flowchart of a process for modifying screen configurations based on a detected event, according to an exemplary embodiment. In step 501, the mobile device 101 detects a new event, such as an incoming call, text message, email, or initiation of an event by the user; as mentioned, the event can include a user defined event, a software event, or a keypress event. For example, the new event can be a text message, which is received while the user is viewing video content. Because the applications are different, the screens and assignment of the screens to the displays (in a multiple display scenario) may require change. Notably, a soft keypad may appear on a touch screen display in a manner that is convenient for the user (depending on the orientation of the mobile device 101). After the text message is read user and responded to by the user, the screen configuration for an optimal or preferred viewing arrangement can be restored.

Per step 503, the screen control module 101c can determine the screen configuration for the detected event. Also, the orientation detector 101d can determine the position of the mobile device 101 at this point. In step 505, the process can thus determine whether orientation of the screen needs to be altered according to the determined screen configuration. The screen configuration, as mentioned earlier, for a particular event can be specified the user. If the orientation needs to be changed, the process modifies the image orientation and display assignment accordingly (step 507). For example, if the device 101 is equipped with four physical displays (or monitors) as in FIG. 3C, the user may have configured the device 101 so that an incoming text message appear on display 303, while video content (e.g., movie) is shown on displays 305 and 307. Additionally, display 301 might be identified as keypad for inputting and sending a reply to the text message.

Furthermore, the screen control module 101c can present the screens in various configurations as the user rotates the mobile device 101 in different orientations.

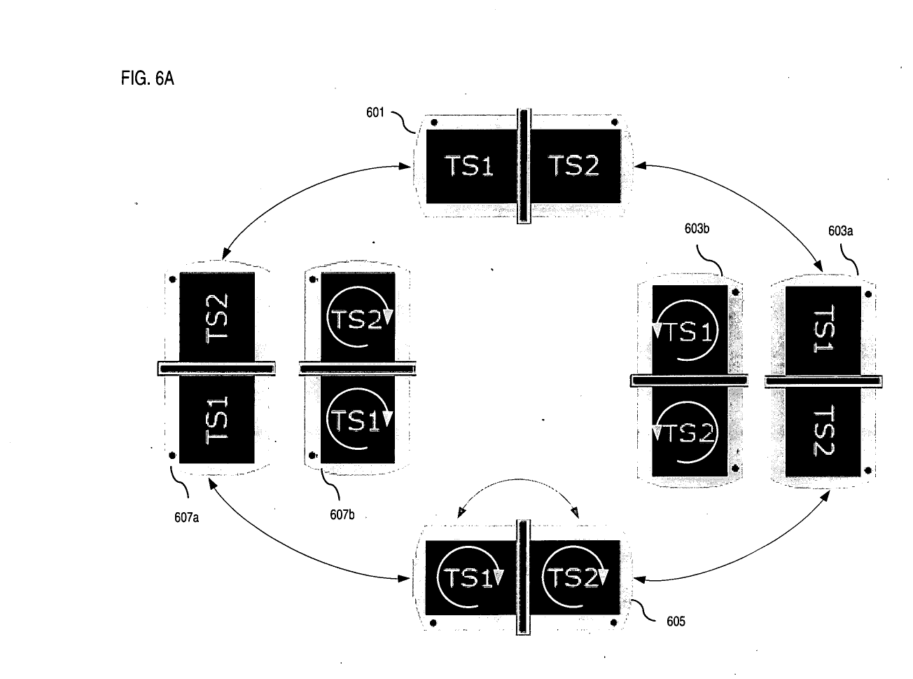

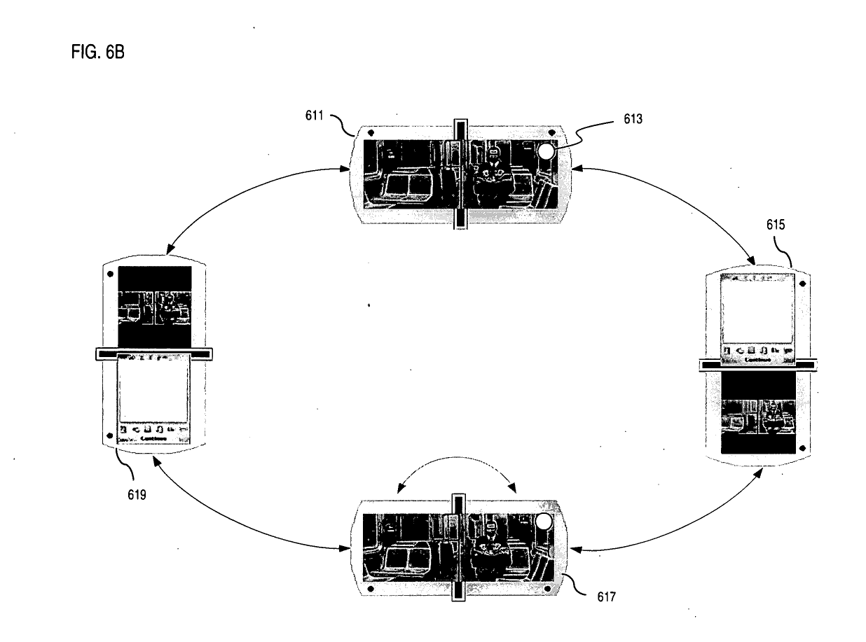

FIGS. 6A and 6B are diagrams of screen orientations dependant on device rotation, according to various exemplary embodiments. For the purposes of explanation, the capability to update the images (or screens) on the displays is described with respect to two displays, which are touch screens. Also, the black “dots” on the corners of the displays are used to provide a frame of reference for the orientation of the displays. In state 601, the device 101 presents two images “TS1” and “TS2” on the left and right displays, respectively. It is noted that TS1 and TS2 could be sub-parts of a common image. In state 603, the device 101 is rotated 90° clockwise. It is assumed that the rotation is intentional. After the rotation is detected by the orientation detector 101d, the screen control module 101c rotates images TS1 and TS2 (state 603a), 90° counter clockwise so that images are leveled for viewing by the user (state 603b). It is contemplated that only one of the images can be rotated, depending on the application and/or user preference.

If the device 101 is rotated another 90° clockwise (which is 180 degrees from initial state), the images are correspondingly rotated another 90° counter clockwise from previous state 603b to state 605. However, at this point the images can be swapped so that TS1 appears on the left side of TS2 as it was in initial state 601. Another 90° clockwise rotation from state 605 to state 607 results in the transition from the images being vertical (state 607a) to the images being horizontal (step 607b).

To further illustrate the flexibility of the screen configurations, this arrangement is explained in FIG. 6B with respect to a user viewing video content, and receiving an incoming message during the viewing.

As seen in FIG. 6B, in state 613, video content (e.g., movie) is being presented on both displays to provide the user with the largest video image. While the movie is being viewed, an incoming message is received (this can indicated by a “circle” or any other indicia in the top right hand corner of the display). Under this example, the user would like to read the message but keep the movie playing. Accordingly, the user rotates the device 101 90° counter clockwise to invoke a message viewer, per state 615. The application that appears when the device 101 is rotated could change based on the type of event. For instance, if an email has been received, the mobile device 101 can launch an email application or web browser to permit the user to access the email. As such, the user can utilize the top display showing an appropriate control screen to retrieve and respond to the email.

Once the user is done with the email application, the user can then rotate the mobile device 101 90° clockwise (to state 617) to go back to a full display mode. It is noted that this state 617 achieves the same effect as state 611, thereby allowing the user greater flexibility; alternatively, state 617 may assume a different viewing mode.

If the user again rotates the device 101 clockwise from state 617 (or initially rotates the device 101 counter clockwise from state 611) to state 619, the screen control module 101c may follow a different configuration than state 615, such that the movie is shown on the upper display. As mentioned, the user can specify what action is required for the screen control module 101c to manipulate the configurations for the displays for a particular event and rotation angle (i.e., orientation).

In the above arrangement, the screen configuration changes are triggered based on 90° rotation angles. However, it is contemplated that more configurations can be employed if more granularity in rotation angles are defined (e.g., 45° rotation angles).

FIG. 7 is a flowchart of process for allowing a user to input screen configuration parameters, according to an exemplary embodiment. In step 701, the mobile device 101 can prompt the user to specify various configuration options and associated parameters. Accordingly, the user can provide input of the appropriate screen parameters for a certain event, as in step 703.

FIG. 8 is a flowchart of a process for a user to set screen configurations for various events, according to an exemplary embodiment. In step 801, the user specifies the time threshold required for declaring that indeed the orientation change is intentional (e.g., 2 seconds, 5 seconds, etc.). For example, if the user sets the value of this threshold to 2 seconds, the screen control module 101c can start a timer upon detection of movement and takes a snapshot of the current device 101 orientation. After the timer expires, the control module 101c compares the current device 101 orientation with the initial orientation and changes the image orientation based on any difference between the two states.

In step 803, the user selects an event from the list of possible events (e.g., text message, call, and email) and then identifies their desired or preferred display (or screen) configuration when the selected event occurs (step 805). Thereafter, the process determines, as in step 807, whether the user seeks to configure another event. For example, the user can browse through a list of possible events and identify the screen configuration for each event. If user does not identify any configuration for one or more events, a default configuration setting can be utilized.

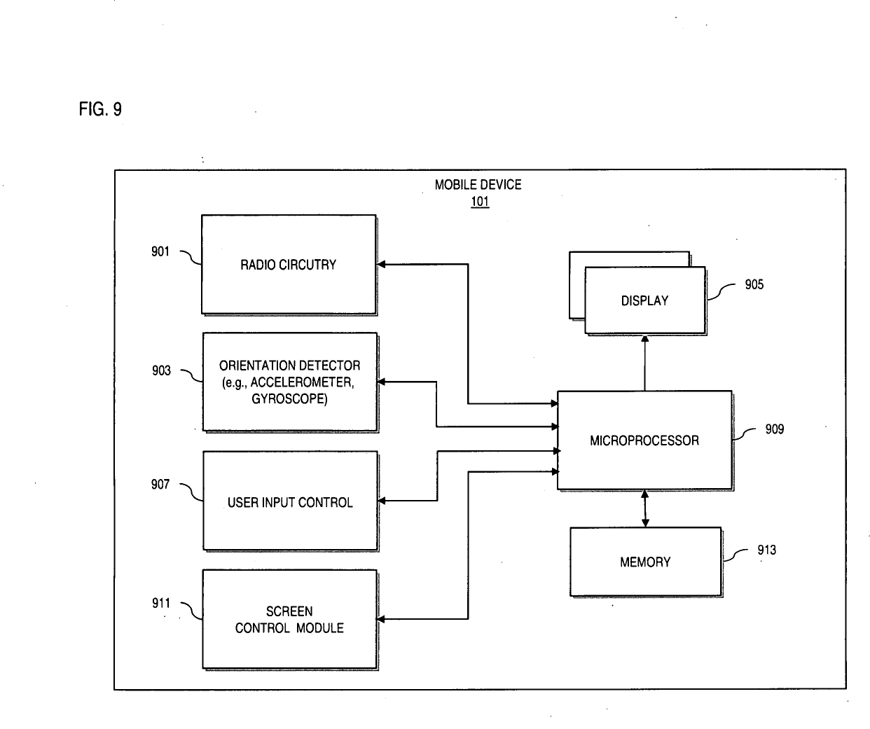

FIG. 9 is a diagram of exemplary components of the mobile device of FIG. 1, according to an exemplary embodiment. In this example, the mobile device 101 includes radio circuitry 901 for communicating over the radio network 103 and an orientation detector 903 (e.g., accelerometer or gyroscope) for measuring movement (e.g., rotation) of the mobile device 101. Additionally, one or more displays 905 are provided to present the images and events.

A user input control button or switch (i.e., input device) 907, such as a keypad including alphanumeric and other keys, is coupled to a bus for communicating information and command selections to a microprocessor 909. Other types of user input device 907 includes a cursor control, a trackball, or cursor direction keys, for communicating direction information and command selections to the microprocessor 909 and for controlling cursor movement on the display 905. In an exemplary embodiment user input control 907 could be virtually simulated on one of the displays 905.

The user input control button or switch 907 allows a user to provide input in connection with the screen control module 911. In summary, the accelerometer 903 provides information as to whether the mobile device 101 is being moved, e.g., rotated; and the user input control button or switch 907 provides the information as to whether this input control button or switch is being depressed to screen control module 911.

The microprocessor 909 processes signals for controlling the display 905 as to permit the display 905 to present an updated image after processing input signals received from the radio circuitry 901, the screen control module 911, and the user input control button or switch 907. The microprocessor 909 executes configuration stored in memory 913 to support display management process. Memory 913 can be random access memory (RAM) or other dynamic storage device. Also, memory 913 can be used for storing temporary variables or other intermediate information during execution of instructions by the microprocessor 909. Such instructions can be read into memory 913 from another computer-readable storage medium (not shown). Execution of the arrangement of instructions contained in memory 913 causes the microprocessor 909 to perform the process steps described herein. One or more processors in a multi-processing arrangement may also be employed to execute the instructions contained in memory 913. In alternative embodiments, hard-wired circuitry may be used in place of or in combination with software instructions to implement certain embodiments. Thus, these embodiments are not limited to any specific combination of hardware circuitry and software.

The term “computer-readable storage medium” as used herein refers to any medium that participates in providing instructions to the microprocessor 909 for execution. Such a medium may take many forms, including but not limited to non-volatile media, volatile media. Non-volatile media include, for example, optical or magnetic disks, such as the storage device. Volatile media include dynamic memory, such as memory 913. Common forms of computer-readable storage media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, or any other medium from which a computing system or microprocessor 909 can read.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
detecting motion of a mobile device having a plurality of displays, wherein each of the displays is configured to present an image; and
changing orientation of one or more of the images on the displays in response to the detected motion.

2. A method according to claim 1, further comprising:
determining occurrence of an event; and
selectively updating the orientation of the images according to the event.

3. A method according to claim 2, wherein the event includes either a call, a text message, or an e-mail.

4. A method according to claim 1, wherein the images are associated with a common application or a common user interface, the common application including a video stream.

5. A method according to claim 1, further comprising:
prompting a user for a configuration option relating to how the change of orientation is triggered with respect to the motion or how the images are presented at different orientation positions.

6. A method according to claim 5, wherein the configuration option includes a time interval threshold associated with a duration by which a new orientation remains prior to triggering a change in orientation.

7. A method according to claim 1, wherein the motion involves rotating the mobile device, and the orientations of the images are preserved with respect to a user.

8. An apparatus comprising:
a detector configured to detect motion of a mobile device having a plurality of displays, wherein each of the displays is configured to present an image; and
a control module configured to change orientation of one or more of the images on the displays in response to the detected motion.

9. An apparatus according to claim 8, wherein the control module is further configured to determine occurrence of an event, and to selectively update the orientation of the images according to the event.

10. An apparatus according to claim 9, wherein the event includes either a call, a text message, an e-mail, a user-defined event, a keypress event, or a software event.

11. An apparatus according to claim 8, wherein the images are associated with a common application or a common user interface, the common application including a video stream.

12. An apparatus according to claim 8, further comprising:
an interface configured to prompt a user for a configuration option relating to how the change of orientation is triggered with respect to the motion.

13. An apparatus according to claim 12, wherein the configuration option includes a time interval threshold associated with a duration by which a new orientation remains prior to triggering a change in orientation.

14. An apparatus according to claim 8, wherein the motion involves rotating the mobile device, and the orientations of the images are preserved with respect to a user.

15. A mobile device comprising:
a plurality of displays, wherein each of the displays is configured to present an image; and
a processor configured to detect motion of the mobile device, and to change orientation of one or more of the images on the displays in response to the detected motion.

16. A device according to claim 15, wherein the processor is further configured to determine occurrence of an event, and to selectively update the orientation of the images according to the event.

17. A device according to claim 16, wherein the event includes either a call, a text message, an e-mail, a user-defined event, a keypress event, or a software event.

18. A device according to claim 15, wherein the images are associated with a common application or a common user interface, the common application including a video stream.

19. A device according to claim 15, wherein the processor is further configured to prompt a user for a configuration option relating to how the change of orientation is triggered with respect to the motion.

20. A device according to claim 19, wherein the configuration option includes a time interval threshold associated with a duration by which a new orientation remains prior to triggering a change in orientation.

21. A device according to claim 15, wherein the motion involves rotating the mobile device, and the orientations of the images are preserved with respect to a user.
